(19) United States
(12) Patent Application Publication
(10) Pub. No.: US 2020/0202442 A1
(43) Pub. Date: Jun. 25, 2020

(54) SYSTEMS AND METHODS FOR INTRINSIC VALUE DRIVEN DYNAMIC ASSET REALLOCATION

(71) Applicant: John Paul Kepros, East Lansing, MI (US)

(72) Inventor: John Paul Kepros, East Lansing, MI (US)

(21) Appl. No.: 16/225,535

(22) Filed: Dec. 19, 2018

(51) Int. Cl. G06Q 40/06; G06Q 40/04; G06F 17/18

(52) U.S. Cl. CPC G06Q 40/06; G06F 17/18; G06Q 40/04

(57) ABSTRACT

A method having the following steps: (1) identifying one or more databases having historical data from a U.S. equity market index; (2) selecting at least one database for analysis; (3) plotting the historical data from the at least one database over a range of time; (4) generating a trend line from the plotted historical data over the range of time; (5) determining a correlation coefficient from the trend line, wherein a larger correlation coefficient indicates a higher degree of accuracy between the trend line and the plotted historical data, and wherein if the correlation coefficient does not exceed a correlation threshold value then selecting another of the one or more databases for analysis; (6) using a trend line formula, extrapolating from the trend line to determine a predicted U.S. equity market index value; (7) obtaining an actual U.S. equity market index value; (8) comparing the actual U.S. equity market index value to the predicted U.S. equity market index value to determine an overprice/underprice value of a current U.S. equity market index; (9) subtracting the overprice/underprice value from a reallocation value to determine a stock percentage value for a target investor portfolio and a non-stock percentage value for the target investor portfolio, wherein the stock percentage value and the non-stock percentage value add up to one-hundred percent; and (10) reallocating the target investor portfolio based on the stock percentage value and the non-stock percentage value.

### FIELD OF THE INVENTION

The present invention generally relates to systems and methods configured to reallocate an investment portfolio that decreases losses when stocks in the investment portfolio are overpriced and takes advantage of growth when stocks in the investment portfolio are underpriced while minimizing or eliminating the hazards of market timing.

### BACKGROUND

There is an estimated 28 trillion dollars invested in the stock market in the United States (U.S.). Approximately one third of it is invested in index funds, funds which have low fees (expense ratios) and directly track the total U.S. stock market providing diversification and avoiding frequent changes in the stocks that comprise the funds. Mutual funds that track the Standard and Poor's (S&P) 500® index are frequently used for this purpose. Despite this passive approach, these funds have overwhelmingly outperformed other mutual funds and have provided impressive returns for little investor effort. The primary risk of this approach is that of the investor selling shares of the funds out of fear or necessity when the price is down as the stock market may, at times, be quite volatile as shown in a graph 1 of the S&P 500® index (FIG. 1).

An accepted strategy to manage this risk is to invest a portion of the portfolio in the total U.S. bond market in the form of a total U.S. bond market index fund which is more stable than the stock market albeit with lower returns. One aspect of this prior-art strategy is to “buy and hold” the stocks regardless of the stock market being “up or “down” with the confidence that the stock market will provide overall growth over time.

The portion of the portfolio allocated to stocks or bonds is described as asset allocation. Asset allocation had been shown by Brinson, et. al. in 1986 to have an important, in fact, the most important impact on overall returns. Most investment companies' web sites represent the investor's current allocation between stocks and bonds by a pie chart for guidance as shown in FIG. 2.

In addition to U.S. stocks and bonds, it is often recommended to have a portion of the stock investment in international stocks as further diversification and as a currency hedge. A complete portfolio can be comprised then of only three index funds, a total U.S. stock market index fund, an international stock market index fund, and a total U.S. bond market index fund. It is not generally recommended to have more than a nominal amount in cash.

The most common recommendation for asset allocation is a strategic or fixed allocation model. For example, it may be recommended that an investor's portfolio consist of 70% stocks and 30% bonds (FIG. 2). Periodically, because the stock and bond allocations will usually grow at different rates, the portfolio will need to be rebalanced back to the initial allocation.

The determination of this allocation is not precise and is usually an estimation considering several personal factors including an investor's age, how close they are to retirement, and how much fear they have of, and actions they would take with, a significant downturn in the stock market. The subjective nature of these factors is a source of weakness in the otherwise very rational investing strategy of stock and bond index funds.

Although periodic rebalancing will shift funds away from the allocation with recent growth and to the one with less growth, it does not consider the current value of the stock market when doing so. This is intentional as it has been deemed impossible to “time the market” and know, with a high degree of certainty what will happen in the future. Nevertheless, the current price of stocks may not reflect the true, or intrinsic value of the stocks due to speculation, inefficiency, and other factors.

There have been attempts to incorporate valuation into asset allocation. They are usually created with the expectation of higher returns than a stock market index. These are typically in the form of actively managed mutual funds that have higher expense ratios than index funds. These funds do not have a target asset allocation like that used in strategic asset allocation but instead rely on the fund manager's experience.

The fund manager may use market data or trends such as the composite price-to-earnings ratio to predict what asset allocation will have higher near-term or long-term returns. Price-to-earnings ratios (PE ratios) require past earnings which may not be representative of future earnings in a company with significant growth or decline. Anticipated future earnings may also be used in to calculate the PE ratio but may be overly optimistic or less commonly overly pessimistic and therefore offer an inadequate predictive value.

Most dynamic asset allocation funds are dependent on the fund manager, do not make the investors aware of the system used to determine dynamic asset allocation, and almost always fail to yield higher returns than stock market index funds over extended periods of time. Although there have been short or moderate term successes, regression to the mean usually obviates longer term success.

### BRIEF SUMMARY OF THE INVENTION

One embodiment of the present invention is generally directed toward at least one non-transitory computer readable medium storing instructions that, when executed by at least one processor, causes the at least one processor to perform a method having the following steps: (1) identifying one or more databases having historical data from a U.S. equity market index; (2) selecting at least one database for analysis; (3) plotting the historical data from the at least one database over a range of time; (4) generating a trend line from the plotted historical data over the range of time; (5) determining a correlation coefficient from the trend line, wherein a larger correlation coefficient indicates a higher degree of accuracy between the trend line and the plotted historical data, and wherein if the correlation coefficient does not exceed a correlation threshold value then selecting another of the one or more databases for analysis; (6) using a trend line formula, extrapolating from the trend line to determine a predicted U.S. equity market index value; (7) obtaining an actual U.S. equity market index value; (8) comparing the actual U.S. equity market index value to the predicted U.S. equity market index value to determine an overprice/underprice value of a current U.S. equity market index; (9) subtracting the overprice/underprice value from a reallocation value to determine a stock percentage value for a target investor portfolio and a non-stock percentage value for the target investor portfolio, wherein the stock percentage value and the non-stock percentage value add up to one-hundred percent; and (10) reallocating the target investor portfolio based on the stock percentage value and the non-stock percentage value.

Another embodiment of the present invention is directed toward at least one non-transitory computer readable medium storing instructions that, when executed by at least one processor, causes the at least one processor to perform a method having the following steps (1) identifying one or more databases having historical data from a U.S. equity market index; (2) selecting at least one database for analysis; (3) plotting the historical data from the at least one database over a first range of time; (4) generating a trend line from the plotted historical data over the first range of time; (5) determining a correlation coefficient from the trend line, wherein a larger correlation coefficient indicates a higher degree of accuracy between the trend line and the plotted historical data, and wherein if the correlation coefficient does not exceed a correlation threshold value then selecting another of the one or more databases for analysis; (6) using a trend line formula, extrapolating from the trend line to determine a predicted U.S. equity market index value; (7) obtaining an actual U.S. equity market index value; (8) comparing the actual U.S. equity market index value to the predicted U.S. equity market index value to determine a U.S. overprice/underprice value of a current U.S. equity market index; (9) subtracting the U.S. overprice/underprice value from a reallocation value to determine a U.S. stock percentage value for a target investor portfolio and a U.S. non-stock percentage value for the target investor portfolio, wherein the U.S. stock percentage value and the U.S. non-stock percentage value add up to one-hundred percent; (10) identifying a U.S. to international market capitalization ratio; (11) obtaining an international equity market index value; (12) determining a ratio of the actual U.S. equity market index value to the international equity market index value; (13) determining a mean value of the ratio over a second range of time; (14) calculating a current daily U.S. equity market index to an international equity market index; (15) determining a price ratio; (16) calculating a target U.S. stock allocation to an international stock allocation ratio; (17) calculating a percentage target value of the target U.S. stock allocation to an international stock allocation; (18) exchanging U.S. equity market index assets and international equity market index assets to achieve a target international to U.S. stock equity allocation while keeping a total stock allocation of U.S. to international stocks the same; and (19) reallocating the target investor portfolio based on the U.S. stock percentage value, the amount of U.S. stocks, and the amount of international stocks.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified:

FIG. 1 is a prior art graph of the S&P 500® index over a period of time;

FIG. 2 is a prior art pie chart showing an example of an investor's asset allocation between stocks and bonds;

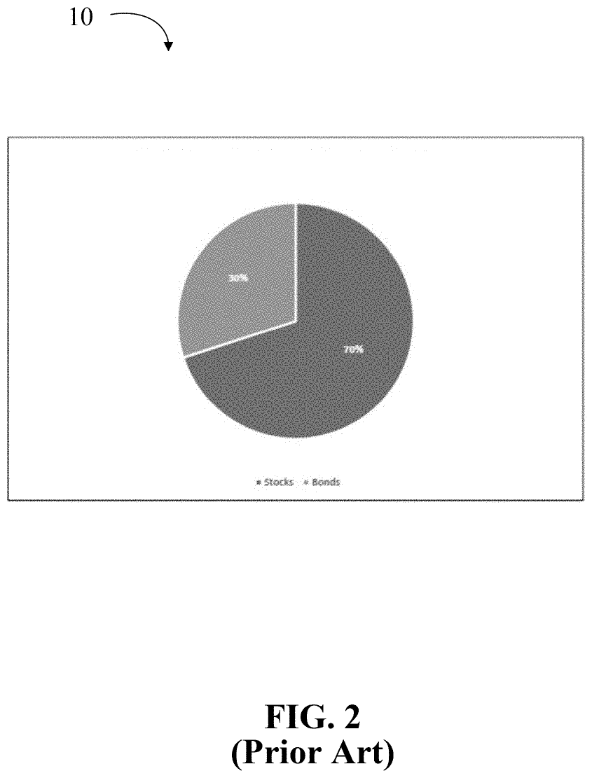

FIG. 3 is a flowchart showing a method for reallocating an investor portfolio according to an embodiment of the present invention;

FIG. 4 is a graph of a trend line plotted over historical market equity index data according to an embodiment of the present invention;

FIG. 5 is a graph of showing a consistency of an intrinsic value determination over different time periods according to an embodiment of the present invention;

FIG. 6 is a graph of an overprice value over a range of time according to an embodiment of the present invention;

FIG. 7 is a graph showing a relationship of an overprice value against ten year returns from an equity market index according to an embodiment of the present invention;

FIG. 8 is a graph showing a relationship of an overprice value against ten year returns from an equity market index with the percentiles of return according to an embodiment of the present invention;

FIG. 9 is a graph showing annualized ten year returns versus an overprice/underprice value over time according to an embodiment of the present invention;

FIG. 10 is a graph showing stock allocation versus overprice for a neutral allocation value of 0.9 (90 percent) according to an embodiment of the present invention;

FIG. 11 is a graph showing stock allocation versus overprice and when the market is overpriced the neutral allocation value of 1.2 (120 percent) would be in stocks but may be purposefully limited to 1.0 (one hundred percent) according to an embodiment of the present invention;

FIG. 12 is a graph showing the improved performance of monthly returns using the method of the present invention as compared to a prior-art “efficient frontier method according to an embodiment of the present invention; and

FIG. 13 is a flowchart showing a method for reallocating an investor portfolio having U.S. stocks and international stocks according to an embodiment of the present invention.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known methods or processes associated with investment asset allocation, index investing (e.g., passive index investing), dynamic asset allocation, modelling historic equity index data to determine an overprice/underprice value, reallocating a target investor portfolio, and the methods of configuring and/or operating any of the above have not necessarily been shown or described in detail to avoid unnecessarily obscuring descriptions of the embodiments of the invention. For purposes of the present description, the term “intrinsic value” is used throughout, but it is understood that this term is not a derived term, but rather a term that represents a macro view of the stock market based on a variety of controllable and non-controllable micro economic factors and events.

The present invention is generally directed to systems and methods configured to reallocate an investment portfolio that decreases losses when stocks in the investment portfolio are overpriced and takes advantage of growth when stocks in the investment portfolio are underpriced. The present invention is further directed to minimizing or eliminating the hazards of market timing.

The total stock market has reliably shown growth over a long-time period albeit with substantial volatility. Much of the volatility is commonly thought to be due to investor speculation as well as economic, domestic political, and international geopolitical events which may or may not have an actual effect on industry growth or revenue. Additionally, there may be “black swan” events, such as the 2008 financial crisis, which need to be planned for as they are impossible to predict. An estimation of the underlying true growth in value of the stock market can be termed the intrinsic value and is the basis for the growth in long term investments. It is also the basis for the “buy and hold” strategy recommended for long-term investors as they may be tempted to sell when prices are low and buy when prices are high.

One embodiment of the present invention includes at least one non-transitory computer readable medium storing instructions that, when executed by at least one processor, causes the at least one processor to perform a computer implemented method to reallocate a target investor portfolio. By way of example, the method may take the form of an intrinsic value driven dynamic asset allocation process that provides an objective, emotionless investment plan that will increase returns and offer a lower level of risk. One objective of the present invention is to avoiding market timing, but instead take advantage of probabilities in the direction of movement by determining the composite intrinsic value of the stock market.

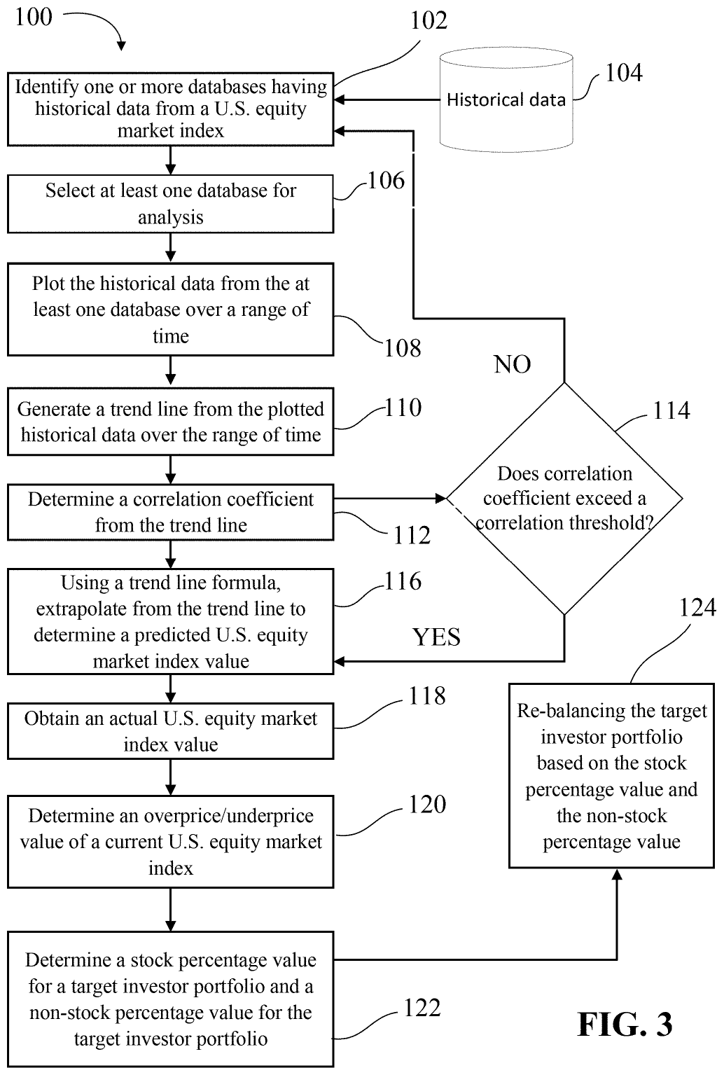

FIG. 3 shows a flowchart of a method 100 of the aforementioned process.

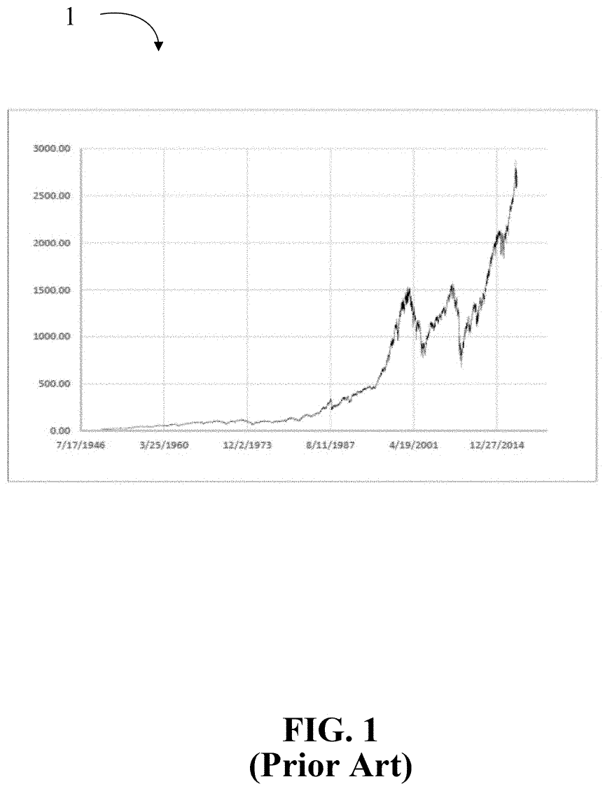

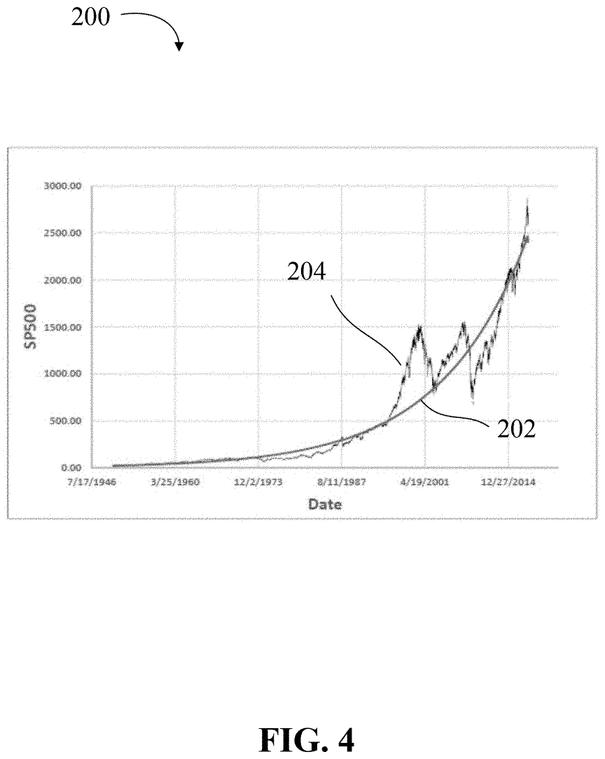

FIGS. 4-12 will also be referenced in the description that follows. At Step 102, the method 100 commences by identifying one or more databases 104 having historical data from a U.S. equity market index. By way of example, the index may be, but is not limited to, the S&P 500® index (FIG. 1). It is appreciated that other indices may be identified such as, but not limited to, Yahoo Finance AGSPC, NASDAQ, and the Dow Jones Industrial Average. At Step 106, one of the indices may be selected for analysis. At Step 108, the historical data from the at least one database is plotted over a range of time. At Step 110 and as shown in a chart 200 displayed in FIG. 4, a trend line 202 from the plotted historical data 204 is generated using a “best fit” mathematical model. In the illustrated embodiment, the historical data 204 is generated from the S&P 500® index and the range of time is greater than fifty years, however the range of time may be less than fifty years. By way of example, the historical data may include historical daily adjusted closing levels of the U.S. equity market index. It is understood that a greater the range of time typically results in greater accuracy for the generated trend line 202. The mathematical model preferably takes the form of an exponential growth trend line. However, other mathematical models may be used to generate the trend line 202 such as, but not limited to, a logarithmic model, a linear regression model, some other model or transform, or some combination of any of the aforementioned models.

By generating the trend line 202 based on the historical data 204, the method 100 may ignore the composite price-to-earnings ratio as well as market conditions (e.g., “bull” or “bear” market) and place the focus on the intrinsic value of the stock market.

Mathematical modeling using “best fit” techniques is commonly used to model natural or man-made phenomena for better understanding the phenomena or for prediction of the future behavior of a system. When the data closely correlates with the mathematical formula then the trend line 202 may produce a higher a correlation coefficient. Because investors assume, and rely on, continual long-term growth of the stock market, it makes sense to better understand and quantitate what drives this growth.

By way of example and using the S&P 500® index, the mathematical formula may take the form of an exponential growth model, hereinafter referred to as a trend line formula, as follows: S&P's 500® Index=C1*e^{(C2*time)}, where “e” is a mathematical constant 2.71828 used in exponential growth models and C1 and C2 are constants determined from historical real-world data using a computer and a spreadsheet with mathematical modeling functionality. Alternatively, the stock market data may be transformed logarithmically, and linear regression can be used.

In the case of the S&P 500® levels modeled exponentially, by way of example and at Step 112, a correlation coefficient may be equal to or greater than 0.95, which indicates a good fit for exponential growth. In at least one embodiment of the present invention, the trend line formula may provide the best fit of the data and represents the best estimate of the underlying or “intrinsic” value of the composite stock market. Over the long-term, the intrinsic value is less subject to the variation caused by investor speculation. At Step 114, if the correlation coefficient does not exceed a correlation threshold then the method 100 may be re-started using a different index identified in Step 102.

If the correlation coefficient does exceed the correlation threshold then the method 100 may continue. In one embodiment, the correlation coefficient may be in a range of about 0.50 to about 1.00. In a preferred embodiment, the correlation coefficient is at least 0.7. As discussed above, the correlation coefficient provides guidance as to how well the trend line formula fits the historical data of the index.

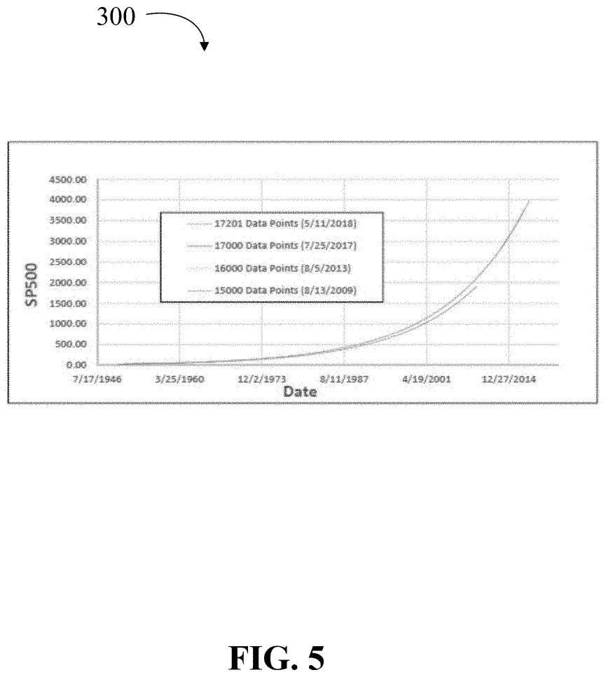

Assuming the calculated correlation coefficient exceeds the correlation threshold, then at Step 116, the trend line may be extrapolated and the trend line formula may be used to determine a “predicted” U.S. market equity index value. FIG. 5 shows a consistency depending on when the curve fitting is performed over different periods of time. The four (4) curves shown are actually taken from four (4) different time periods—each with a different number of data points. They all start on the same day relative to that given year. For example if the curve fitting was performed in 2009, it is very close to what one would get in 2018 even though only 15,000 data points were used in the 2009 curve. The other three curves are so close they overlap completely so it only looks like two curves. By way of example, if a curve fit were performed today than it should still be quite accurate ten (10) years from now. At Step 118, obtain an “actual” equity market index value. In one embodiment, the actual equity market index value takes the form of a closing value of the selected equity market index for a particular day.

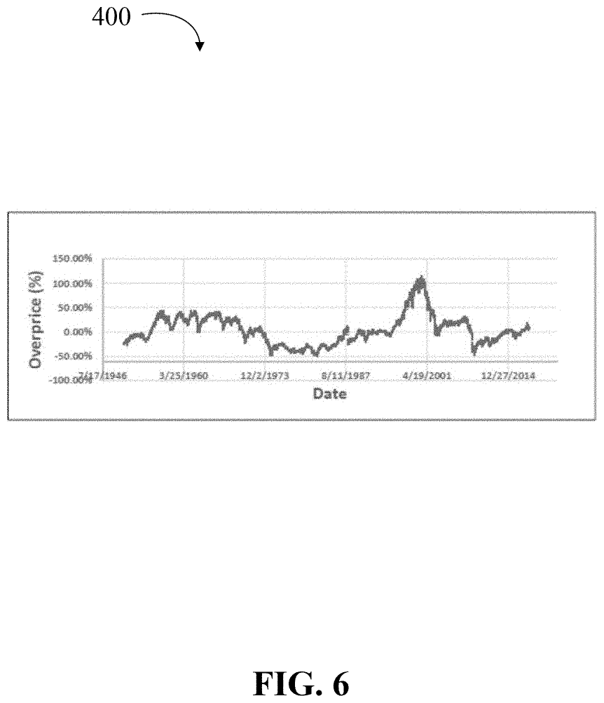

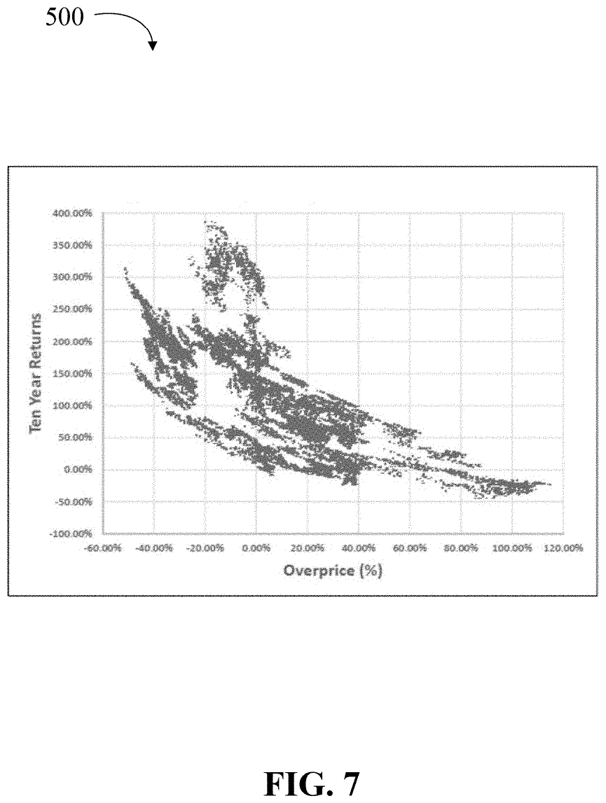

At Step 120, determine an overprice/underprice value of a current U.S. equity market index by comparing the actual U.S. equity market index value to the predicted U.S. equity market index value. The method 100 allows for many applications that can add insight into stock market behavior. For example, it can be determined if the current stock market is overpriced or underpriced. FIG. 6 is a graph 400 that shows the relationship between current overprice and returns, which can used to be better understood the role of speculation in stock market valuations. Although there may be significant variation in ten-year returns, further analysis shows that about half of the variation can be predicted by the current overprice of the market and that the magnitude of the overprice correlates with the magnitude of the ten-year returns as shown in graph 500 in FIG. 7.

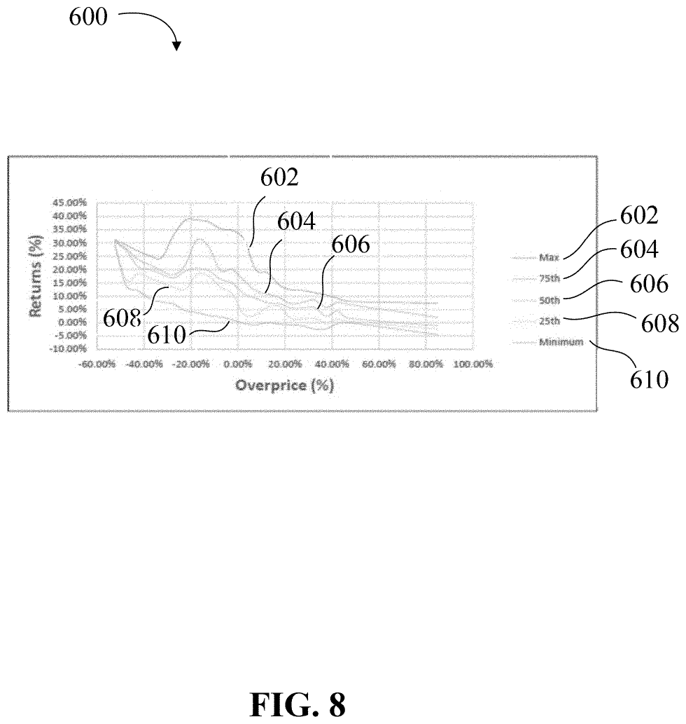

By way of example, FIG. 8 shows a graph 600 that plots the relationship of overprice and ten year S&P 500® returns. By examining the quartiles of returns vs. overprice, there is much more variation at negative overprice levels (underprice) although with much higher returns. The quartiles are shown graphed lines, as follows: line 602=a maximum quartile return; line 604=75^{th} percent quartile return; line 606=50^{th} percent quartile return; line 608=25th percent quartile return; and line 610=maximum quartile return. At high overprice levels, the median 10-year return is negative. Because this is predictable, it suggests that this characteristic (overprice) may be incorporated into a new and improved investing strategy that modifies existing fixed allocation strategies.

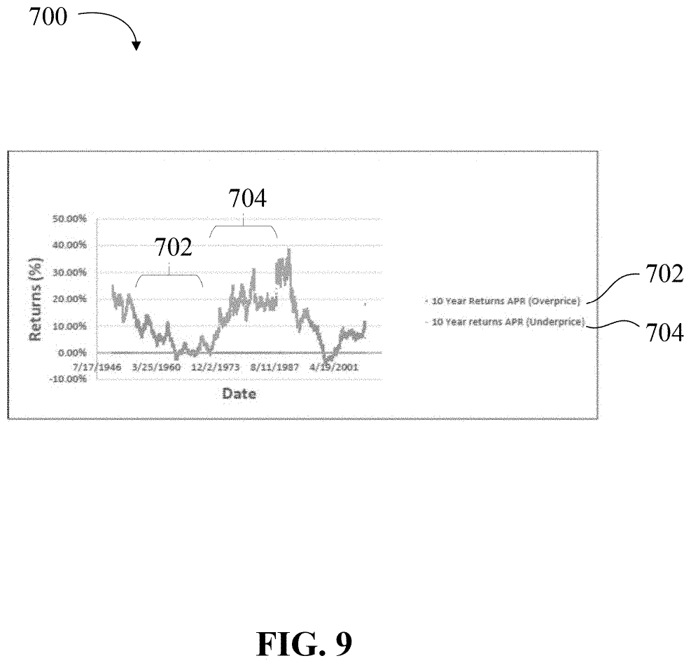

FIG. 9 shows a graph 700 indicating that an investor may have an investing advantage by increasing stock allocation when stocks are underpriced (line 702) vs overpriced (line 704). Conversely at high overprice, for example over forty percent, the advantage of stock allocation as compared to bond allocation dwindles.

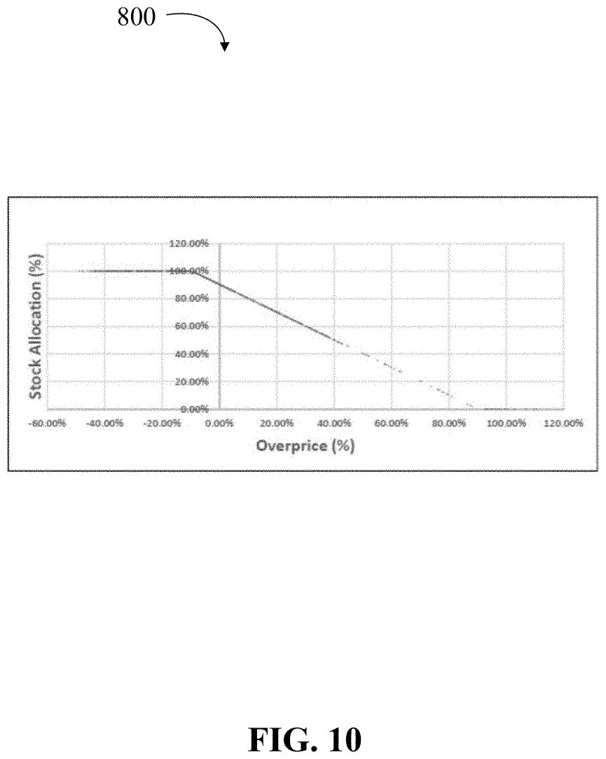

At Step 122, the overprice/underprice value is subtracted from a reallocation value to determine a stock percentage value for a target investor portfolio and a non-stock percentage value for the target investor portfolio. The stock percentage value and the non-stock percentage value add up to one-hundred percent. In one embodiment, the non-stock percentage value includes an amount of bonds, fixed income, or a combination of bonds and fixed income. Additionally and as shown in FIG. 10, the stock allocation versus overprice for a neutral allocation value of 0.9, which means that if the market is neither overpriced or underpriced then 90% of assets will be in stocks. It is appreciated that the reallocation value may be set at other levels, which is explained below in more detail. At Step 124, the target investor portfolio based on the stock percentage value and the non-stock percentage value is re-balanced or reallocated.

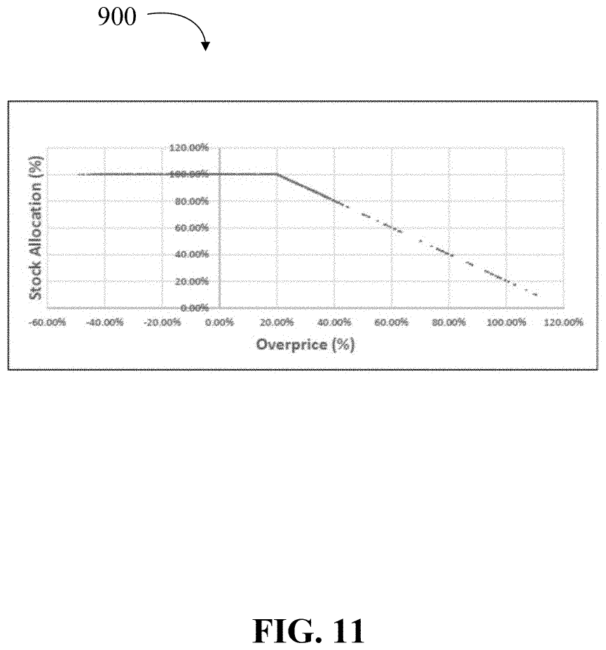

In one example of how a fixed stock allocation strategy can be modified directly is illustrated in a graph 800 of FIG. 11. In graph 800, the reallocation would be ninety percent stocks at an even intrinsic value. The intrinsic value is the predicted value of the stock market based on the model. It is the dependent variable and the date (time) is the independent variable. The intrinsic value may not be the actual value because of the many factors involved in determining current price. The intrinsic value is, however, the most likely value. At present time, uncertainty is dealt with by hedging by investing more of the portfolio in bonds. The amount or percentage of bonds becomes more if the actual value is higher than the intrinsic value as the actual value is more likely to decrease than if it was at a neutral value. The fixed stock allocation strategy provides a precise, yet moving average, based on that there will be a regression to the mean regardless of market conditions. Accordingly, the actual value will eventually follow the intrinsic value as it has done ninety-six percent of the time in the past. The reallocation is then modified by a direct percentage based solely on the overvalue percent. For example, if the stock market is ten percent overpriced, the allocation would be reallocated to eighty percent stocks and twenty percent bonds. In another example and if the stock market is five percent underpriced, the allocation would be reallocated to ninety-five percent stocks and five percent bonds. The reallocation may be done as frequently or infrequently as desired depending on the size of the target investor portfolio, the activity of the stock or bond market, and a variety of other factors. In one embodiment, the investor may reallocate the target investor portfolio on a monthly or quarterly basis.

Preferably, an upper limit of the stock reallocation value is one hundred percent. Generally, it is ill advisable to leverage other assets to increase the reallocation value to be greater than one hundred percent; although the method 100 permits that there may be circumstances of extreme underprice where this would be theoretically advantageous. Similarly, the reallocation value may have a lower limit of zero percent stocks and one hundred percent bonds for an extreme overprice situation. In another embodiment of the present invention, the method 100 may allow for a modification in which the reallocation value may be greater than one hundred percent stocks. If the maximum and minimum stock allocations are adhered to, the method 100 merely changes the thresholds for the reallocation value. By way of example, FIG. 11 shows a graph 900 in which the reallocation value is modified to 1.2 or one hundred and twenty percent. By decreasing the stock exposure by decreasing allocation at high overprice levels, it is possible to decrease risk while maintaining, or even increasing returns. When stocks are underpriced, there is a reserve of assets (e.g., bonds) that can then be traded for stocks during the rebalance.

Balancing an investment portfolio based on return versus risk may be best described in the classic article titled “Portfolio Selection” by Harry Markowitz published in the journal Finance in 1952. Markowitz coins the phrase “efficient frontier” as a set of portfolios that have the highest expected returns for a given level of risk. Return can be represented by the mean returns over a period. Risk can be represented by standard deviation or variance. Sufficiently diversified fixed allocation strategies with differing stock allocations can form the frontier.

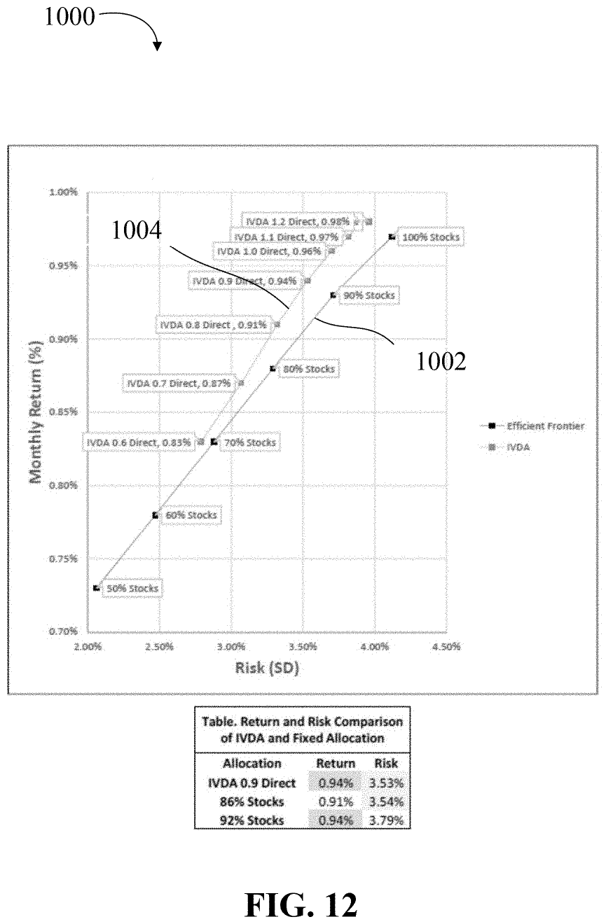

As shown in FIG. 12, the target investment portfolio is analyzed using Markowitz's efficient frontier method as compared to method 100 of the present invention. As illustrated, an efficient frontier line 1002 routinely is less than (i.e., provides a lower return) than an intrinsic value line 1004 derived using method 100. One possible advantage of the method 100 is that an investor may see a higher return combined with a lower amount of risk as compared to Markowitz's efficient frontier method. By way of example and referring to table 1006, the method 100 achieves a monthly return of about ninety-four percent while Markowitz's efficient frontier method achieves a monthly return of about ninety-two percent for the same level of risk. In one embodiment, the above-described method may apply to only international stocks and bonds or a portfolio of stocks and bonds in a country besides the United States.

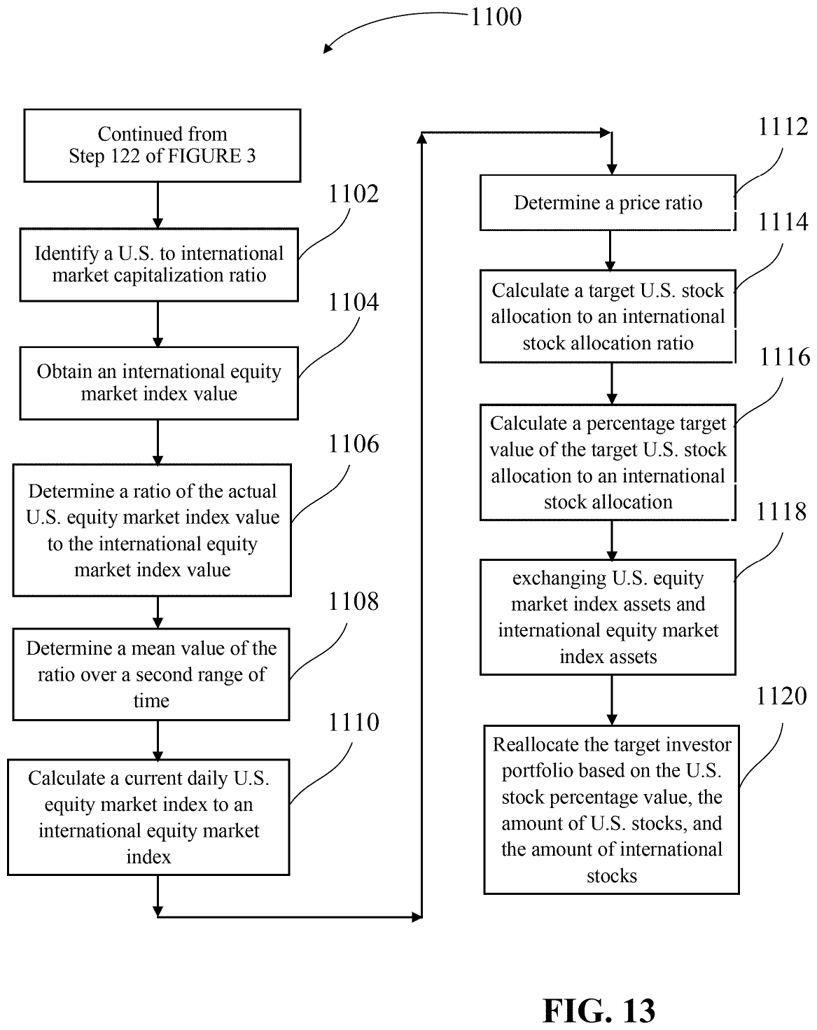

FIG. 13 shows a flowchart 1100 that combines method 100, described above, with a target investment portfolio that includes international stocks. Generally there is a high correlation between domestic and international stocks. Current practices indicate that one should have about twenty percent of one's stock allocation in international stocks as a currency hedge and because sometimes when one is up the other is down so it would serve a diversification function as well. Nevertheless and according to an embodiment of the present invention, the percentage of domestic versus international stocks may be weighted by market capitalization (e.g., a total number of stocks multiplied by an average share price) and generally a market capitalization ratio of domestic versus international stocks comes out to be around fifty percent, which means that one's stock allocation would be about fifty percent domestic stock and about fifty percent international stock. In the event there is a larger than average divergence between the value of domestic stocks versus international stocks, the international stocks may be a better investment either because they will catch up or domestic stocks will fall down to the level of international. In one embodiment of the present invention, the initial allocation of domestic versus international stocks may commence at fifty percent of each type of stock and then may be adjusted based on an amount of divergence while maintaining the total stock reallocation the same as determined in the flow chart of FIG. 3.

FIG. 3 is hereby incorporated by reference into the flow chart of FIG. 13 in that Step 1102 sequentially follows Step 124 of FIG. 3. At Step 1102, identify a U.S. to international market capitalization ratio. At Step 1104, obtain an international equity market index value. At Step 1106, determine a ratio of the actual U.S. equity market index value to the international equity market index value. At Step 1108, determine a mean value of the ratio over a second range of time. At Step 1110, calculate a current daily U.S. equity market index to an international equity market index. At Step 1112, determine a price ratio of the current U.S. to international equity market index ratio divided by a mean U.S. to international equity market index ratio. At Step 1114, calculate a target U.S. stock allocation to an international stock allocation ratio. At Step 1116, calculate a percentage target value of the target U.S. stock allocation to an international stock allocation. At Step 1118, exchange U.S. equity market index assets and international equity market index assets to achieve a target international to U.S. stock equity allocation while keeping a total stock allocation of U.S. to international stocks the same. And at Step 1120, reallocate the target investor portfolio based on the U.S. stock percentage value, the amount of U.S. stocks, and the amount of international stocks.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. At least one non-transitory computer readable medium storing instructions that, when executed by at least one processor, causes the at least one processor to perform a method comprising:
identifying one or more databases having historical data from a U.S. equity market index;
selecting at least one database for analysis;
plotting the historical data from the at least one database over a range of time;
generating a trend line from the plotted historical data over the range of time;
determining a correlation coefficient from the trend line, wherein a larger correlation coefficient indicates a higher degree of accuracy between the trend line and the plotted historical data, and wherein if the correlation coefficient does not exceed a correlation threshold value then selecting another of the one or more databases for analysis;
using a trend line formula, extrapolating from the trend line to determine a predicted U.S. equity market index value;
obtaining an actual U.S. equity market index value;
comparing the actual U.S. equity market index value to the predicted U.S. equity market index value to determine an overprice/underprice value of a current U.S. equity market index;
subtracting the overprice/underprice value from a reallocation value to determine a stock percentage value for a target investor portfolio and a non-stock percentage value for the target investor portfolio, wherein the stock percentage value and the non-stock percentage value add up to one-hundred percent; and
rebalancing the target investor portfolio based on the stock percentage value and the non-stock percentage value.

2. The method of claim 1, wherein generating the trend line includes using at least one of an exponential growth model, a logarithmic model, or a linear regression model.

3. The method of claim 1, wherein the range of time commences at least fifty years before obtaining the actual U.S. equity market index value.

4. The method of claim 1, wherein the range of time commences within fifty years before obtaining the actual U.S. equity market index value.

5. The method of claim 1, wherein the correlation threshold value is about 0.7.

6. The method of claim 1, wherein the non-stock percentage value includes an amount of bonds, fixed income, or a combination of bonds and fixed income.

7. The method of claim 1, wherein the historical data includes historical daily adjusted closing levels of the U.S. equity market index.

8. The method of claim 1, wherein the actual U.S. equity market index value is a closing value of the selected U.S. equity market index for a particular day.

9. The method of claim 1, wherein selecting the at least one database for analysis includes selecting the S&P 500 equity market index.

10. The method of claim 1, wherein the neutral allocation value is about 0.9.

11. At least one non-transitory computer readable medium storing instructions that, when executed by at least one processor, causes the at least one processor to perform a method comprising:
identifying one or more databases having historical data from a U.S. equity market index;
selecting at least one database for analysis;
plotting the historical data from the at least one database over a first range of time;
generating a trend line from the plotted historical data over the first range of time;
determining a correlation coefficient from the trend line, wherein a larger correlation coefficient indicates a higher degree of accuracy between the trend line and the plotted historical data, and wherein if the correlation coefficient does not exceed a correlation threshold value then selecting another of the one or more databases for analysis;
using a trend line formula, extrapolating from the trend line to determine a predicted U.S. equity market index value;
obtaining an actual U.S. equity market index value;
comparing the actual U.S. equity market index value to the predicted U.S. equity market index value to determine a U.S. overprice/underprice value of a current U.S. equity market index;
subtracting the U.S. overprice/underprice value from a reallocation value to determine a U.S. stock percentage value for a target investor portfolio and a U.S. non-stock percentage value for the target investor portfolio, wherein the U.S. stock percentage value and the U.S. non-stock percentage value add up to one-hundred percent;
identifying a U.S. to international market capitalization ratio;
obtaining an international equity market index value;
determining a ratio of the actual U.S. equity market index value to the international equity market index value;
determining a mean value of the ratio over a second range of time;
calculating a current daily U.S. equity market index to an international equity market index;
determining a price ratio;
calculating a target U.S. stock allocation to an international stock allocation ratio;
calculating a percentage target value of the target U.S. stock allocation to an international stock allocation;
exchanging U.S. equity market index assets and international equity market index assets to achieve a target international to U.S. stock equity allocation while keeping a total stock allocation of U.S. to international stocks the same; and
reallocating the target investor portfolio based on the U.S. stock percentage value, the amount of U.S. stocks, and the amount of international stocks.

12. The method of claim 1, wherein generating the trend line includes using at least one of an exponential growth model, a logarithmic model, or a linear regression model.

13. The method of claim 1, wherein the second range of time is at least ten years.

14. The method of claim 1, wherein selecting the at least one database for analysis includes selecting the S&P 500 equity market index.

15. The method of claim 1, wherein the correlation threshold value is about 0.7.

16. The method of claim 1, wherein the non-stock percentage value includes an amount of bonds, fixed income, or a combination of bonds and fixed income.

17. The method of claim 1, wherein the historical data includes historical daily adjusted closing levels of the U.S. equity market index.

18. The method of claim 1, wherein obtaining the international equity market index value is a daily closing value of the international equity market index for a particular day.

19. The method of claim 1, wherein the fixed correlation value is about 0.76.

20. The method of claim 1, wherein determining the ratio of the actual U.S. equity market index value to the international equity market index value included dividing the actual U.S. equity market index value by the international equity market index value.
